(19) United States
(12) Patent Application Publication
(10) Pub. No.: US 2021/0370604 A1
(43) Pub. Date: Dec. 2, 2021

(54) ADDITIVE MANUFACTURING SYSTEM AND METHOD

(71) Applicant: Hewlett-Packard Development Company, L.P., Spring, TX (US)

(72) Inventors: Jordi Roca Vila, Sant Cugat del Valles (ES); Sergio Gonzalez Martin, Sant Cugat del Valles (ES); Josep M. Asensio Buchaca, Sant Cugat del Valles (ES)

(73) Assignee: Hewlett-Packard Development Company, L.P., Spring, TX (US)

(21) Appl. No.: 15/734,602

(22) PCT Filed: Jan. 31, 2019
(86) PCT No.: PCT/US2019/016018

§ 371 Date: Dec. 3, 2020

(51) Int. Cl. B29C 64/386; B33Y 50/00; G05B 19/4099

(52) U.S. Cl. CPC B29C 64/386; B33Y 50/00; G05B 2219/49023; G05B 2219/35134; G05B 19/4099

(57) ABSTRACT

A method comprising obtaining an input, wherein the input comprises a three-dimensional representation of an object, the three-dimensional representation comprising a plurality of portions, wherein each of the plurality of portions has associated portion properties, and obtaining printer properties of a plurality of printing devices. The printer properties correspond to at least one feature of the printing devices; and the method assigns each of the plurality of portions to respective ones of the plurality of printing devices by comparing the portion properties with the printer properties, and assigning the portion to one of the printing devices based on the comparison, such that each of the plurality of portions has a respective assigned printing device. Each of the portions are then provided to its respective assigned printing device.

### BACKGROUND

Manufactured products may be made of a number of separate parts each of which may be constructed from a single material or from multiple materials and then assembled together to create a single product. Alternatively, products may be manufactured using an additive manufacturing system, such as a three-dimensional (3D) printing system which may use a build material to form a 3D object, such as by fusing particles of the build material in layers, whereby the 3D object is generated on a layer-by-layer basis.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a flowchart illustrating a method according to an example;

FIG. 2 is a schematic illustration of a 3D printing system according to an example; and

FIG. 3 is a schematic illustration of allocating portions of a 3D object to a plurality of 3D printing devices according to an example.

### DETAILED DESCRIPTION

3D objects may be generated or produced using additive manufacturing/3D printing techniques. The objects may be generated by solidifying portions of successive layers of build material. The build material can be, for example, powder-based, and the material properties of the generated objects may be dependent on the type of build material used and the nature of the solidification process. In some examples, the solidification of the powder material is enabled using a liquid fusing agent. In other examples, solidification may be enabled by the temporary application of energy to the build material. In certain examples, fusing agents are applied to the build material, wherein a fuse agent is a material that, when a suitable amount of energy is applied to a combination of build material and fuse agent, causes the build material to melt, fuse, sinter, coalesce or otherwise solidify. In other examples, other build materials and other methods of solidification may be used, such as a chemical binder system using a chemical binding agent. In certain examples, the build material may be in the form of a paste or a slurry.

Examples of build materials for additive manufacturing include polymers, crystalline plastics, semi-crystalline plastics, polyethylene (PE), polylactic acid (PLA), acrylonitrile butadiene styrene (ABS), amorphous plastics, polyvinyl alcohol plastic (PVA), polyamide (e.g., nylon), thermo(setting) plastics, resins, transparent powders, colored powders, metal powder, ceramics powder such as for example glass particles, and/or a combination of at least two of these or other materials wherein such combination may include different particles each of different materials or different materials in a single compound particle. Examples of blended build materials include alumide, which may include a blend of aluminum and polyamide, and plastics or ceramics blends. There exist more build materials and blends of build materials that can be managed by an apparatus of this disclosure and that are not mentioned in this disclosure.

A 3D object may be generated by a 3D printing device based on a specification defined within a print file. An object may be formed from one or more parts. The print file allows a part to be represented using a mesh formed from geometrical shapes, such as polygons. A color or texture image may be assigned to the surface of the geometrical shapes. In an example, the print file may be a computer-aided design file such as a file in a 3MF file format.

The print file may define a number of specifications or properties of the part to be printed, such as material, size, shape, granularity, texture and color. “Granularity” refers to the level of detail a 3D printing device is capable of outputting. The higher the granularity the more detailed the objects printed by the 3D printing device are. Granularity may be considered as a three-dimensional equivalent to a two-dimensional print resolution, for example. For example, the granularity of each of the specifications can be a general definition applied to the whole of a part or a specific definition applied to a portion of the part, such as a polygon, or part of a polygon. Each print file may contain information regarding an object to be printed by a 3D printing device. The object may comprise a number of portions each having associated properties, such that the properties of one portion may be different to the properties of another portion.

Some properties may be defined as a range or a gamut. For example, the color properties of a part may be defined as a range of colors present in the part, such as when the part has more than one color and/or when surface decoration is required. In one example, the print file may define a solid color per part, whereby a single color is assigned to the whole part in question. Alternatively, the print file may define a color per geometrical shape defining the part, for example, per polygon or per triangle. In other examples, the print file may define color per vertex of the geometrical shape. In the latter case, there are different ways to define the color, which may be used alone or in combination with one another. In one example, the color per vertex definition may assign a different color, for example a different sRGB color, to each vertex to achieve a gradient of colors within the geometrical shape. In a further example, each vertex may have two coordinates (u, v) identifying a portion of a color or image (also referred to as a “texture”) to be mapped to the vertex. The same principles apply to other properties including elasticity, rigidity, conductivity and granularity for example.

In example 3D printing systems, the print file may be provided to a computer application, for example, a software application, that translates the print file into printing instructions for a 3D printing device of the 3D printing system.

The print file is obtained by the 3D printing system and comprises printing instructions that define a 3D object. The print file also indicates to the 3D printing system the properties or characteristics that each part or portion of the 3D object is to have. For example, a first part may be defined to be made of a metal material, a second part may be defined to be made of a green plastics material, and a third part may be defined to be made of a red plastics material. As well as the material, the parts may also have other properties which differ, for example, a defined granularity or a defined rigidity of the part. Likewise, some parts may have the same material but have other properties which differ.

The 3D printing system also comprises a plurality of 3D printing devices, with each 3D printing device having associated printer properties including settings, configurations and/or material type properties which are obtained by the 3D printing system. For example, the 3D printing devices can be capable of printing using a plastics material or metal material, capable of printing different colors, and capable of printing at different granularities. Other properties or characteristics of the 3D printing devices may also be provided to the 3D printing system such as whether the 3D printing device is capable of printing objects with a range of characteristics such as a particular elasticity, for example.

The characteristics of the plurality of 3D printing devices are then be used to assign each of the portions of the object to be produced to a 3D printing device based on the properties of the portion. This is achieved by comparing the 3D printing device properties with the properties associated with the portions of the object to be printed. Once the portions have been assigned to a 3D printing device, the portion is provided to the assigned 3D printing device to be produced.

This enables an object comprising a number of portions to be printed by one or more 3D printing devices, where the portions have different properties. By printing portions of an object on different 3D printing devices based on their properties, the entire object may be produced more quickly or may have portions displaying different properties which cannot be produced by a single 3D printing device.

In some examples, a user of the 3D printing system may load the file, such as a computer-aided design file into the system. The computer-aided design file comprises information relating to the 3D object to be printed, such as a 3D model of the object, and the portions of said objects. The file may also comprise further information detailing the desired properties associated with each of the portions of the object, for example, the color, material, conductivity, granularity of the portion to be printed. In other examples, a user of the print system may assign the properties to the portions based on the desired characteristics of the object to be printed. Other properties such as elasticity and rigidity may also be associated with the portions to be printed. This enables both mass production of an object having known properties, and also customization of an object based on a user's desired characteristics.

As well as assigning portions of the object to one of the 3D printing devices based on the comparison between the properties associated with the portion and the capabilities of the 3D printing device, the process of assigning the portion may also comprise determining a status of the 3D printing devices of the system. For example, the 3D printing system may determine which of the 3D printing devices are currently available to print the portion of the object. If a 3D printing device having substantially similar characteristics and properties as those of the portion of the object to be printed is currently in use, the portion may be grouped with other portions having substantially similar characteristics, and sent to a second, idle, 3D printing device if one is available, thereby increasing the output of the 3D printing system. This may be achieved by making multiple copies of a portion, or arranging portions of the same object which have the same or similar characteristics on the print bed, and producing them simultaneously.

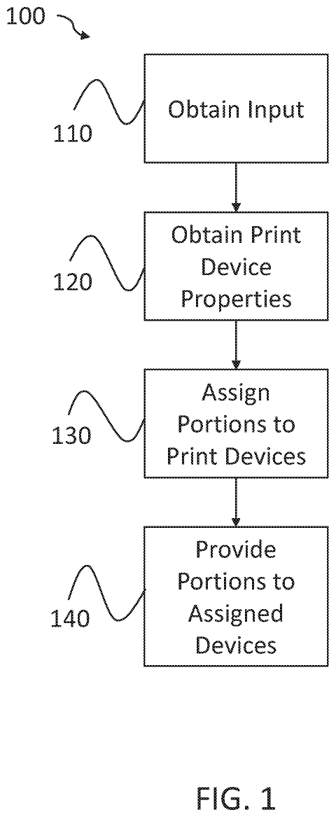

FIG. 1 is a flowchart illustrating a method according to an example. At item 110, an input is obtained. The input may be in the form of a computer-aided design file, such as a 3MF file, and may contain a three-dimensional representation of an object to be printed by a 3D printing system. The input may define a number of portions of the object to be printed, with each portion having associated characteristics. For example, each portion may have properties indicating at least one of color, texture, granularity, elasticity, rigidity, material type, and conductivity. In further examples, the file may define a range of characteristics for a particular portion, such as a portion which has multiple colors or varying textures.

In some examples, the input may be obtained from storage of the 3D printing system. The storage may, for example, be a random-access memory (RAM) such as DDR-SDRAM (double data rate synchronous dynamic random-access memory). In other examples, the storage may be or include a non-volatile memory such as Read Only Memory (ROM) or a solid-state drive (SSD) such as Flash memory. The storage in examples may include further storage devices, for example magnetic, optical or tape media, compact disc (CD), digital versatile disc (DVD) or other data storage media. The storage may be removable or non-removable from the 3D printing system. In other examples, the input may be obtained from storage remote to the 3D printing system, for example, an internet connected device, or a remote server.

At item 120 print device properties, configuration settings or characteristics are obtained. For example, the properties of each of the 3D printing devices of the 3D printing system are indicative of the capabilities of each device. The properties indicate whether the 3D printing device can print color, and if so what colors can be produced, what materials the 3D printing device is configured to print with, such as a plastics material, a metal, or a metal alloy, and what granularity the 3D printing device is capable of outputting. Other properties may also be provided to the 3D printing system. Each of the properties can be predefined by the 3D printing device itself, or alternatively are set by a user of the 3D printing device. In some examples, each of the 3D printing devices provides the properties to the 3D printing system. In other examples, the 3D printing system stores or obtains the properties from storage, such as storage associated with the 3D printing system or storage of a remote device or server. The properties associated with each of the 3D printing devices may be indicative of a range of characteristics. For example, the range of characteristics may include at least one of the colors a 3D printing device is capable of printing, texture, granularity or any other of the suitable characteristics that the 3D printing device is capable of.

At item 130, each of the portions of the object in the input file is assigned to one of the 3D printing devices of the 3D printing system. To determine which of the 3D printing devices the portion of the object is assigned to, the properties of that portion are compared with the characteristics of each of the 3D printing devices.

The properties of the portions are each compared to the characteristics of the 3D printing devices. Based on this comparison the portions are assigned to one of the 3D printing devices of the 3D printing system. For example, the if a portion is to be printed using a green plastics material then this portion will be assigned to the 3D printing device which can produce an output using a green plastics material. Similarly, if a portion is defined to have a multicolor exterior portion, then it will be assigned to a 3D printing device capable of printing different colors on the exterior surface.

In some examples, multiple portions of an object are be assigned to a single 3D printing device if those portions have substantially similar properties and the 3D printing device is capable of producing the portions with the desired characteristics. This enables a 3D printing system to more efficiently organize the portions on a print bed, so a single 3D printing device can produce multiple copies of the portion at the same time, by grouping the portions together and producing them in the same print run. In yet further examples, the 3D printing system is instructed to produce multiple copies of an object from a single file. In such an example, the 3D printing system provides multiple copies of a portion to a single 3D printing device at the same time and arranged such that the number of copies of the object may be produced in a minimum amount of time, such as by grouping components with substantially similar properties and producing them in the same print run. In another example, the 3D printing system obtains multiple inputs, such as in the form of multiple computer-aided design files each containing objects to be produced comprising different portions. In this example, the 3D printing system compares the properties of the portions with the capabilities of the 3D printing devices and groups portions having similar properties for sending to a corresponding 3D printing device. This enables portions of different objects to be produced by grouping and arranging them such that they may be produced in the same print run.

In further examples, where more than one 3D printing device is capable of producing portions with the desired properties, the 3D printing system allocates portions based on the availability of the 3D printing devices. As such, a system may have a first 3D printing device and a second 3D printing device both of which are capable of producing an output with the desired properties. If first 3D printing device is currently in use, or unavailable for another reasons, such as it is undergoing maintenance, the portions allocated to a printing device with the characteristics of the first and second 3D printing devices can be provided to the second 3D printing device.

At item 140, once each of the portions has been allocated to one of the 3D printing devices, the portions are provided to the corresponding 3D printing devices for production. For example, the one or more portions, along with their settings and an arrangement on the print bed, may be provided to the 3D printing devices for production. Once the portions have been produced by the 3D printing devices, they may be constructed by a user into the object represented in the input file. Where multiple copies of the portion are to be produced which cannot be produced by a single 3D printing device in a single print run, another 3D printing device of the 3D printing system having the substantially similar capabilities may be used. The copies of the portions may split into a plurality of groups and arranged on the print beds of the multiple 3D printing devices, such that they can be produced by the two 3D printing devices substantially simultaneously.

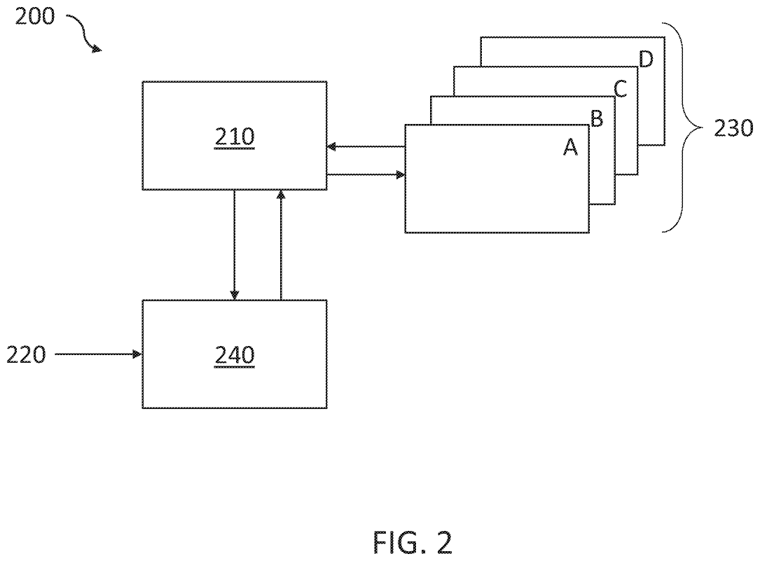

FIG. 2 is a schematic illustration of a 3D printing system according to an example. The 3D printing system 200 comprises a print management system 210, arranged to receive an input 210, a plurality of 3D printing devices A, B, C, D, represented collectively as 230, and a processor 240. In some examples, the processor 240 may be part of the print management system 210, or alternatively as shown in FIG. 2, it may be separate from the print management system, for example, it may form part of a separate device.

The processor 240, obtains an input from storage. The input may be a computer-aided design file, such as a 3MF file. The storage may form part of the 3D printing system 200 or may alternatively be remote to the 3D printing system 200, for example in an internet connected device.

The processor 240 determines the properties of portions of the object in the input file. These properties may be included in the data of the input file 220, or alternatively, they may be provided by a user of the 3D printing system 200 via a user interface. The user of the 3D printing system 200 may also alter, adjust or otherwise amend the properties of the portion. For example, a user may determine that a part which was indicated in the input file 220 to be produced using a green plastics material is instead to be produced using a red plastics material, or a white plastics material with a green color applied to the exterior.

The print management system 210 obtains information regarding the plurality of 3D printing devices 230 forming part of the 3D printing system 200, and forwards these to the processor 240. For example, the print management system 210 may obtain characteristics of the 3D printing devices, such as what material they are capable of using, the color of the material, whether they are capable of producing objects having areas with differing elasticity, rigidity, or conductivity characteristics, and whether they are capable of printing colors on an object as it is produced. Other characteristics and capabilities may also be provided to the print management system 210. In other examples, the characteristics of the 3D printing devices 230 can be stored in the storage of the 3D printing system 200 or on a remote device, such as internet-connected storage, and then provided to the print management system 210.

The processor 240 compares the properties of the plurality of portions of the object defined in the input file 220, and the characteristics or capabilities of the 3D printing devices 230 to determine which of the 3D printing devices 230 have the appropriate capabilities to produce each portion of the object. As mentioned above in relation to FIG. 1, multiple portions of the object may be sent to be produced by a single 3D printing device where they have substantially similar properties. Alternatively, the processor 240 may receive multiple input files 220, each input file 220 having a plurality of portions, analyze said portions and determine which of the portions have substantially similar properties such that they are capable of being produced by the same 3D printing device 230. This can increase the efficiency and output of the 3D printing system 200, by grouping the portions together to be produced at the same time by a single 3D printing device.

In some examples, the processor 240 may form part of the print management system 210 such that the print management system 210 is arranged to receive an input 220 and the 3D printing device 230 capabilities without the need to forward the capabilities to an external device to be processed.

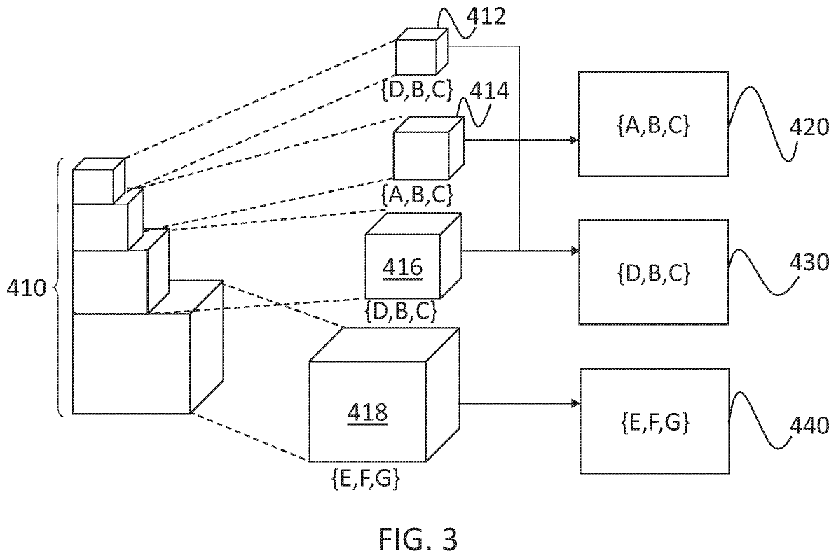

Once the processor 240 has determined which portion of the object defined in the input 220 is to be allocated to a 3D printing device 230, this information is used by the print management system 210 to allocate each of the portions of the object in the input 220 to the corresponding 3D printing device 230, as will be described in more detail below in relation to FIG. 3.

The portions of the object defined in the input 220, or in the case where multiple inputs 220 are provided, portions which form part of the objects defined in the multiple inputs 220, are then produced by the 3D printing devices 230 to be assembled by the user upon completion of the print run.

FIG. 3 is a schematic illustration of the allocation of portions 412, 414, 416, 418 of a 3D object 410 to a plurality of 3D printing devices 420, 430, 440.

The 3D object 410 may be received by a 3D printing system in an input file, such as a computer-aided design file containing information regarding physical properties of the object 410. For example, the physical properties can include one or more of the shape, structure, color, texture, conductivity, rigidity, and any other characteristics or properties of the object 410. The 3D object 410 may have a number of portions, such as portions 412, 414, 416, 418 each having associated characteristics or properties as described above. For example, the portions 412, 414, 416, 418 may have an associated color or material. In some examples one or more of the portions have substantially similar properties, such as having the same color or material.

The 3D printing system comprises a plurality of 3D printing devices 420, 430, 440. The 3D printing devices 420, 430, 440 have different characteristics and capabilities. For example, a first printing device 420 may have a first set of capabilities as shown in FIG. 3, these are represented as a set {A, B, C}, representing a green (A), plastic (B), and rigid (C) portion, for example Other 3D printing devices in the 3D printing system may have overlapping capabilities, such as the second printing device 430 which has capabilities {D, B, C} representing a blue (D), plastic (B), and rigid (C) portion, for example. Conversely, a 3D printing device may have an entirely different set of capabilities, such as the third printing device 440 which has capabilities {E, F, G} representing a silver (E), metal (F), electrically conductive (G) portion, for example. The properties of each 3D printing device may relate to any of the material, color, color printing capability, electrical conductivity of the material, rigidity, elasticity, or any other property capable of being output by a 3D printing device

A processor of the 3D printing system, such as processor 240 of the 3D printing system 200 shown in FIG. 2, deconstructs the 3D object 410 into each of the portions 412, 414, 416, 418 and determines their associated properties. As shown in FIG. 3, a first portion 412 has properties {D, B, C}, a second portion 414 has properties {A, B, C}, a third portion 416 has properties {D, B, C}, and a fourth portion 418 has properties {E, F, G}. These properties are then compared to the capabilities of the 3D printing devices 420, 430, 440 of the 3D printing system.

In some examples, the properties of the portion 412, 414, 416, 418 are not determined by the input file, they may be allocated to each portion 412, 414, 416, 418 by a user of the 3D printing system. Similarly, where the properties are defined by the input file, they may be modified by a user of the 3D printing system. For example, the 3D printing system may determine whether a 3D printing device is capable of producing a portion 412, 414, 416, 418 having the desired characteristics. If not, then the 3D printing system may flag that it is not possible to produce at least one of the portions 412, 414, 416, 418. In such an example the system receives an input adjusting the characteristics of the one or more of the portions 412, 414, 416, 418 such that it is capable of being produced by a 3D printing device.

Once it has been determined what the properties of the portions 412, 414, 416, 418 are, they are allocated to one of the 3D printing devices 420, 430, 440 according to the capabilities of the 3D printing device 420, 430, 440. In some examples, other factors can also be considered when allocating portions 412, 414, 416, 418 to one of the 3D printing devices 420, 430, 440, such as a status of a 3D printing device 420, 430, 440, indicating whether the 3D printing device currently in use.

As shown in FIG. 3, the first portion 412 and the third portion 416 each have substantially similar properties, which in turn correspond to the capabilities of the second printing device 430. Accordingly, the first portion 412 and the third portion 416 are provided to the second printing device 430 for production. In some examples, the properties of the portions and the characteristics of the 3D printing device may exceed a predetermined similarity threshold for the portion, or portions to be allocated to that 3D printing device. The second portion 414 has properties which correspond to the capabilities of the first printing device 420 and accordingly it is provided to the first printing device 420. The fourth portion 418 has properties which correspond to the third printing device 440, and as such, it is provided to the third printing device 440.

In some examples, the properties and capabilities do not need to match exactly, for example, the granularity of a portion may be represented as a range of values and if a 3D printing device is capable of producing the portion with a granularity within the desired range, the portion may be allocated to that 3D printing device.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method comprising:
obtaining an input, wherein the input comprises a three-dimensional representation of an object, the three-dimensional representation comprising a plurality of portions, wherein each of the plurality of portions has associated portion properties;
obtaining printer properties of a plurality of printing devices; the printer properties corresponding to at least one feature of the printing devices;
assigning each of the plurality of portions to respective ones of the plurality of printing devices, by:
comparing the portion properties with the printer properties; and
assigning the portion to one of the printing devices based on the comparison, such that each of the plurality of portions has a respective assigned printing device; and
providing each of the portions to its respective assigned printing device.

2. The method of claim 1, wherein the printer properties comprise at least one of material type, color, elasticity, rigidity, conductivity and granularity.

3. The method of claim 1, wherein the portion properties comprise at least one of material type, color, elasticity, rigidity, conductivity and granularity.

4. The method of claim 1, wherein the input is a computer-aided design file.

5. The method of claim 1, further comprising receiving an input of a property of at least one of the plurality of portions.

6. The method of claim 1, wherein assigning the portion to one of the printing devices is based on a status of each printing device.

7. A print system comprising:
a print management system for controlling a plurality of printing devices, the printing devices having at least one printer characteristic, wherein the printer characteristics correspond to at least one feature of the printing devices;
a processor for receiving an input comprising a three-dimensional depiction of an item, the three-dimensional depiction comprising a plurality of components having associated component characteristics;
allocating the components to respective ones of the plurality of printing devices, by:
comparing the component characteristics with the printer characteristics; and
allocating the component to one of the printing devices based on the comparison, such that each of the plurality of portions has a respective allocated printing device; and
providing each of the components to its respective allocated printing device.

8. The print system of claim 7, wherein the printer properties comprise at least one of material type, color, elasticity, rigidity, conductivity and granularity.

9. The print system of claim 7, wherein the portion properties comprise at least one of material type, color, elasticity, rigidity, conductivity and granularity.

10. The print system of claim 7, wherein the input is received from storage associated with the printing system or from an external device.

11. The print system of claim 7, wherein the input is a computer-aided design file.

12. The print system of claim 7, further comprising receiving an input of a property of at least one of the plurality of portions.

13. The print system of claim 7, wherein assigning the portion to one of the printing devices is based on a status of each printing device.

14. A non-transitory computer-readable storage medium comprising a set of computer-readable instructions that, when executed by a processor of a printing system cause the processor to:
receive an input, wherein the input comprises a three-dimensional representation of an item, the three-dimensional representation comprising a plurality of portions, wherein each of the plurality of portions has associated portion characteristics;
receive printer characteristics of a plurality of printing devices; the printer properties corresponding to at least one feature of the printing devices;
assign each of the plurality of portions to respective ones of the plurality of printing devices, by:
comparing the portion characteristics with the printer characteristics; and
assigning the portion to one of the printing devices where the portion characteristics and printer characteristics are substantially similar, such that each of the plurality of portions has a respective assigned printing device; and
provide each of the portions to the assigned printing device.
